(19) United States
(12) Patent Application Publication
(10) Pub. No.: US 2026/0349112 A1
(43) Pub. Date: Nov. 5, 2026

(54) MEASUREMENT APPARATUS AND MEASUREMENT METHOD

(71) Applicant: Panasonic Intellectual Property Management Co., Ltd., Osaka (JP)

(72) Inventors: TASUKU NAKAMURA, Osaka (JP); SHINYA OKAMOTO, Kyoto (JP); KATSUYA NOZAWA, Osaka (JP); KAZUYA HISADA, Nara (JP)

(21) Appl. No.: 19/710,502

(22) Filed: Jun. 17, 2026

Related U.S. Application Data
(63) Continuation of application No. PCT/JP2024/044396, filed on Dec. 16, 2024.

(30) Foreign Application Priority Data
Jan. 12, 2024 (JP) 2024-003597

(51) Int. Cl. G01S 17/08; G01S 7/481

(52) U.S. Cl. CPC G01S 17/08; G01S 7/4815

(57) ABSTRACT

A measurement apparatus includes a first laser light source that is a mode-locked laser light source including a gain medium and that emits first laser light, a second laser light source that is a mode-locked laser light source including a gain medium and that emits second laser light, at least one first detector that detects at least one selected from the group consisting of the first laser light, the second laser light, and beat light caused by the first laser light and the second laser light, and a feedback circuit that changes at least one selected from the group consisting of an optical spectrum of the first laser light and an optical spectrum of the second laser light on a basis of intensity of a signal output from the at least one first detector.

### BACKGROUND

### 1. Technical Field

The present disclosure relates to a measurement apparatus and a measurement method.

### 2. Description of the Related Art

A laser light source called an optical frequency comb laser or simply called an optical comb laser is known. Specifically, the optical frequency comb laser is a light source that outputs laser light in which pulse waveforms are arranged at equal intervals on a time axis and spectra are arranged at equal intervals on a frequency axis. The laser light is also called an optical comb.

For example, Japanese Unexamined Patent Application Publication (Translation of PCT Application) No. 2012-519879 discloses a coherent dual scanning laser system that performs control in such a way as to stabilize a difference between carrier-envelope offset frequencies (f_{CEO}) of two oscillators.

### SUMMARY

In one general aspect, the techniques disclosed here feature a measurement apparatus including a first laser light source that is a mode-locked laser light source including a gain medium and that emits first laser light, a second laser light source that is a mode-locked laser light source including a gain medium and that emits second laser light, at least one first detector that detects at least one selected from the group consisting of the first laser light, the second laser light, and beat light caused by the first laser light and the second laser light, and a feedback circuit that changes at least one selected from the group consisting of an optical spectrum of the first laser light and an optical spectrum of the second laser light on a basis of intensity of a signal output from the at least one first detector.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1A is a diagram schematically illustrating an example of temporal changes in an electric field of an optical comb;

FIG. 1B is a diagram schematically illustrating a frequency spectrum of the optical comb;

FIG. 2 is a diagram illustrating a frequency spectrum of each of first and second optical combs in a dual comb and interference light caused as a result of interference between these two optical combs;

FIG. 3 is a diagram illustrating a problem that can arise in a dual comb;

FIG. 4 is a diagram illustrating configuration of a measurement apparatus according to a first embodiment;

FIG. 5 is a flowchart illustrating operation of the measurement apparatus according to the first embodiment;

FIG. 6 is a diagram illustrating configuration of a measurement apparatus according to a second embodiment;

FIG. 7 is a diagram illustrating a relationship between frequency spectra of the first and second optical combs and bandpass filters;

FIG. 8 is a flowchart illustrating operation of the measurement apparatus according to the second embodiment;

FIG. 9 is a diagram illustrating configuration of a measurement apparatus according to a modification of the embodiments;

FIG. 10 is a diagram illustrating a relationship between the frequency spectra of the first and second optical combs and a bandpass filter; and

FIG. 11 is a flowchart illustrating operation of the measurement apparatus according to the modification of the embodiments.

### DETAILED DESCRIPTIONS

A detector might not be able to accurately detect output light just by stabilizing a difference between carrier-envelope offset frequencies as in the example of the related art. A decrease in detection accuracy of the detector leads to a decrease in measurement accuracy of a measurement apparatus.

The present disclosure, therefore, provides a measurement apparatus and a measurement method having increased measurement accuracy.

### Outline of Present Disclosure

A measurement apparatus according to a first aspect of the present disclosure includes a first laser light source that is a mode-locked laser light source including a gain medium and that emits first laser light, a second laser light source that is a mode-locked laser light source including a gain medium and that emits second laser light, at least one first detector that detects at least one selected from the group consisting of the first laser light, the second laser light, and beat light caused by the first laser light and the second laser light, and a feedback circuit that changes at least one selected from the group consisting of an optical spectrum of the first laser light and an optical spectrum of the second laser light on a basis of intensity of a signal output from the at least one first detector.

With this configuration, an overlap between frequency bands of the first laser light and the second laser light can be increased by changing the optical spectrum of at least one selected from the group consisting of the first laser light and the second laser light. Since intensity of the beat light caused by the first laser light and the second laser light can be increased, therefore, measurement accuracy can be increased. In addition, since a spectrometer need not be used, the measurement apparatus can be downsized, and the amount of processing can be reduced.

A measurement apparatus according to a second aspect of the present disclosure is the measurement apparatus according to the first aspect. In the second aspect, the first laser light source and the second laser light source may be integrated on a same semiconductor substrate.

A measurement apparatus according to a third aspect of the present disclosure is the measurement apparatus according to the first aspect. In the third aspect, the first laser light source may be disposed on a semiconductor substrate different from a semiconductor substrate on which the second laser light source is disposed.

According to the second and third aspects, the measurement apparatus can be downsized. A frequency band of a laser light source integrated on a semiconductor substrate tends to deviate from a desired value due to a process error and the like. The overlap between the frequency bands of the first laser light and the second laser light, therefore, tends to be small. An effect of improving the measurement accuracy produced by changing the optical spectrum, therefore, is more useful.

A measurement apparatus according to a fourth aspect of the present disclosure is the measurement apparatus according to any of the first to third aspects. In the fourth aspect, the feedback circuit may change the optical spectrum at a frequency higher than at least one selected from the group consisting of a repetition frequency of the first laser light and a repetition frequency of the second laser light.

With this configuration, even when the frequency bands of the first laser light and the second laser light are significantly different from each other, the optical spectrum can be changed in such a way as to increase the overlap. With the measurement apparatus according to the present aspect, therefore, the measurement accuracy can be increased.

A measurement apparatus according to a fifth aspect of the present disclosure is the measurement apparatus according to any of the first to fourth aspects. In the fifth aspect, the intensity of the signal output from the at least one first detector may be peak intensity of pulses of light detected by the at least one first detector.

With this configuration, a measurement apparatus having high measurement accuracy can be achieved with a simple configuration without using a spectrometer.

A measurement apparatus according to a sixth aspect of the present disclosure is the measurement apparatus according to any of the first to fourth aspects. The measurement apparatus according to the sixth aspect may further include at least one bandpass filter. The at least one bandpass filter may be disposed such that light that has passed through the at least one bandpass filter is incident on the at least one first detector. The intensity of the signal output from the at least one first detector may be intensity of the light that has passed through the at least one bandpass filter.

With this configuration, a measurement apparatus having high measurement accuracy can be achieved with a simple configuration without using a spectrometer.

A measurement apparatus according to a seventh aspect of the present disclosure is the measurement apparatus according to any of the first to sixth aspects. In the seventh aspect, the feedback circuit may change the optical spectrum by adjusting an amount of current applied to the gain medium.

With this configuration, an optical spectrum of laser light emitted from a so-called on-chip comb can be effectively changed.

A measurement apparatus according to an eighth aspect of the present disclosure is the measurement apparatus according to any of the first to seventh aspects. The measurement apparatus according to the eighth aspect may further include a second detector that detects interference light caused as a result of interference between reflected light caused when the first laser light is reflected from a target and the second laser light, and a signal processor that calculates a distance from the measurement apparatus to the target on a basis of a signal output from the second detector.

With this configuration, since the distance from the measurement apparatus to the target is measured, the measurement apparatus can be used for ranging, measurement of a surface shape of the target, and the like.

A measurement apparatus according to a ninth aspect of the present disclosure is the measurement apparatus according to any of the first to eighth aspects. The measurement apparatus according to the ninth aspect may further include a signal processor that calculates a distance from the measurement apparatus to a target on a basis of the signal output from the at least one first detector.

With this configuration, the first detector can be used for both measurement and feedback. Therefore, the measurement apparatus according to the present aspect can be downsized.

A measurement apparatus according to a tenth aspect of the present disclosure is the measurement apparatus according to the sixth aspect. The measurement apparatus according to the tenth aspect may further include a second detector that detects interference light caused as a result of interference between reflected light caused when the first laser light is reflected from a target and the second laser light, a third detector that detects interference light caused as a result of interference between the first laser light and the second laser light, and a signal processor that calculates a distance from the measurement apparatus to the target on a basis of a signal output from the second detector and a signal output from the third detector.

With this configuration, since the distance from the measurement apparatus to the target is measured, the measurement apparatus can be used for ranging, measurement of a surface shape of the target, and the like. In addition, since the detector for measuring a distance and the detector for feedback are individually included, a detector suitable for each purpose can be used.

A measurement apparatus according to an eleventh aspect of the present disclosure is the measurement apparatus according to the tenth aspect. In the eleventh aspect, the at least one first detector may include a plurality of first detectors. The at least one bandpass filter may include a plurality of bandpass filters. One of the plurality of first detectors may detect the first laser light that has passed through a first corresponding bandpass filter among the plurality of bandpass filters. Another of the plurality of first detectors may detect the second laser light that has passed through a second corresponding bandpass filter among the plurality of bandpass filters.

With this configuration, intensity of component light of each of the first laser light and the second laser light that has passed through the bandpass filter can be obtained, and the optical spectrum can be easily adjusted.

A measurement apparatus according to a twelfth aspect of the present disclosure is the measurement apparatus according to the tenth aspect. In the twelfth aspect, the at least one first detector may detect the beat light caused by the first laser light and the second laser light that have passed through the at least one bandpass filter.

With this configuration, since the number of detectors and the number of bandpass filters can be reduced, the measurement apparatus can be downsized.

A measurement method according to a thirteenth aspect of the present disclosure includes detecting, using a detector, at least one selected from the group consisting of first laser light emitted from a first laser light source that is a mode-locked laser light source including a gain medium, second laser light emitted from a second laser light source that is a mode-locked laser light source including a gain medium, and beat light caused by the first laser light and the second laser light, and changing at least one selected from the group consisting of an optical spectrum of the first laser light and an optical spectrum of the second laser light on a basis of intensity of a signal output from the detector.

With this configuration, as with the measurement apparatus according to each of the above aspects, the measurement accuracy can be increased.

Embodiments will be specifically described hereinafter with reference to the drawings.

All the embodiments described hereinafter are general or specific examples. Values, shapes, materials, components, arrangement positions and connection modes of the components, steps, order of the steps, and the like mentioned in the following embodiments are examples, and are not intended to limit the present disclosure. Among the components in the following embodiments, ones not described in the independent claims will be described as optional components.

The drawings are schematic diagrams, and are not necessarily strict illustrations. Therefore, scales, for example, are not consistent between the drawings. In the drawings, essentially the same components are given the same reference numerals, and redundant description thereof is omitted or simplified.

In the present specification, a range of values is not an expression having a strict meaning but is an expression indicating inclusion of substantially the same range, that is, for example, a difference of about several percent.

In the present specification, ordinal numbers such as “first” and “second” do not mean the number or order of components unless otherwise noted, but are used to avoid confusion between similar components and to distinguish such components from each other.

### First Embodiment

### Optical Comb Laser

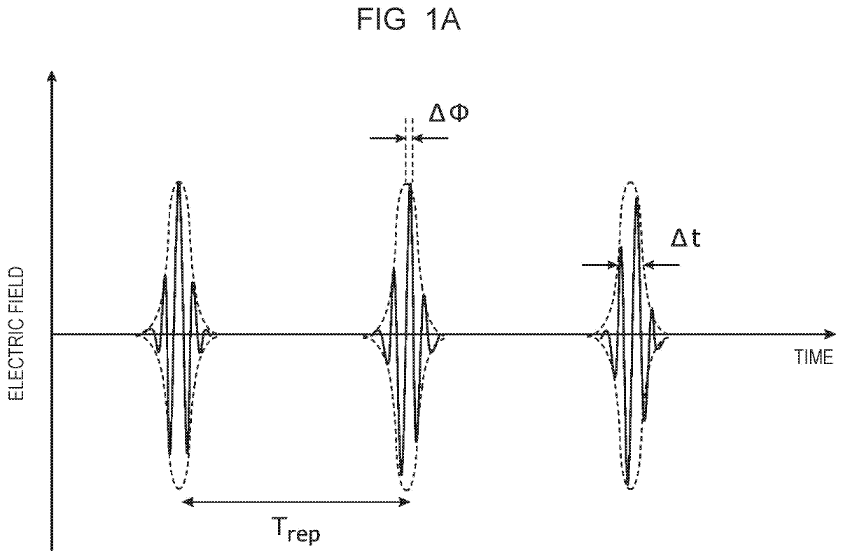

First, a basic principle of optical comb laser will be briefly described with reference to FIGS. 1A and 1B.

FIG. 1A is a diagram schematically illustrating an example of temporal changes in an electric field of an optical comb. In FIG. 1A, a horizontal axis represents time, and a vertical axis represents the electric field of the optical comb. An optical comb is also called an optical frequency comb, optical comb laser light, or optical frequency comb laser light. In the present specification, an optical comb may be simply referred to as laser light.

As illustrated in FIG. 1A, the optical comb includes an optical pulse train generated with a repetition period Tᵣₑₚ. The repetition period Tᵣₑₚ is, for example, longer than or equal to 1 ps and shorter than or equal to 100 ns. A full width at half maximum (FWHM) of each optical pulse is denoted by Δt. The FWHM of each optical pulse Δt is, for example, larger than or equal to 10 fs and smaller than or equal to 100 ps.

In a laser resonator, a group velocity v_{g}, at which an envelope of an optical pulse propagates, and a phase velocity vₚ, at which a wave within the optical pulse propagates, take different values due to dispersion within the resonator and the like. Due to the difference between the group velocity v_{g} and the phase velocity vₚ, when two adjacent optical pulses are overlapped such that envelopes thereof coincide, phases of waves within these optical pulses shift by Δφ. Δφ takes a value between 0 and 2π. A repetition period of an optical pulse train is represented by Tᵣₑₚ=L/v_{g}, where L denotes a round-trip length of the laser resonator.

FIG. 1B is a diagram schematically illustrating a frequency spectrum of an optical comb. In FIG. 1B, a horizontal axis represents frequency, and a vertical axis represents intensity of the optical comb.

As illustrated in FIG. 1B, the optical comb has a comb-shaped frequency spectrum formed by a plurality of discrete and equally spaced lines. The plurality of discrete and equally spaced lines corresponds to resonance frequencies of the laser resonator in longitudinal modes. A repetition frequency corresponding to an interval between two equally spaced lines adjacent to each other in the optical comb is represented by fᵣₑₚ=1/Tᵣₑₚ. The repetition frequency fᵣₑₚ is, for example, higher than or equal to 10 MHz and lower than or equal to 1 THz. When the round-trip length L of the laser resonator is 30 cm and the group velocity v_{g} is substantially equal to the speed of light in vacuum (=3×10⁸ m/s), the repetition period Tᵣₑₚ is 1 ns and the repetition frequency fᵣₑₚ is 1 GHz.

When the FWHM of the optical comb is Δf, Δf=1/Δt. The FWHM Δf of the optical comb is, for example, larger than or equal to 10 GHz and smaller than or equal to 100 THz. Assuming that the equally spaced lines extend to near zero frequency, a frequency of a line closest to zero frequency is referred to as a carrier-envelope offset frequency. The carrier-envelope offset frequency is represented by f_{CEO}=(Δφ/(2π))fᵣₑₚ. The carrier-envelope offset frequency f_{CEO} takes a value between 0 and the repetition frequency fᵣₑₚ. When the carrier-envelope offset frequency f_{CEO} is assumed to be a zeroth mode frequency, an n-th mode frequency fₙ in the optical comb is represented by fₙ=f_{CEO}+nfᵣₑₚ. The electric field of the optical comb illustrated in FIG. 1A is represented by E(t)=Σn Eₙ exp[-i(2π fₙt+φₙ)], where Eₙ and φₙ denote amplitude and phase of the electric field at the n-th mode frequency fₙ, respectively.

### Dual Comb

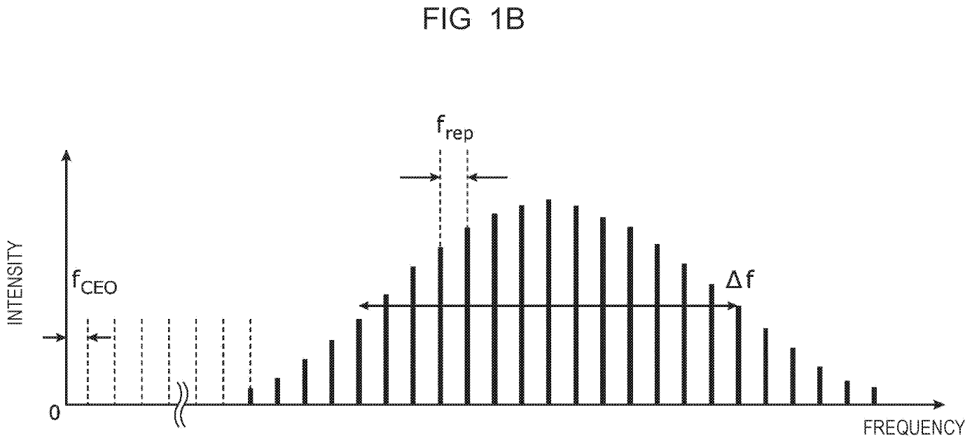

Next, a principle of a dual comb will be briefly described with reference to FIG. 2.

FIG. 2 is a diagram illustrating frequency spectra of first and second optical combs in the dual comb and interference light caused as a result of interference between the two optical combs. In the first optical comb, an n-th mode frequency f₁ₙ is represented by f₁ₙ=f_{CEO1}+nfᵣₑₚ₁. In the second optical comb, an n-th mode frequency f₂ₙ is represented by f₂ₙ=f_{CEO2}+nfᵣₑₚ₂. f_{CEO1} is a carrier-envelope offset frequency of the first optical comb. f_{CEO2} is a carrier-envelope offset frequency of the second optical comb. fᵣₑₚ₁ is a repetition frequency of the first optical comb. fᵣₑₚ₂ is a repetition frequency of the second optical comb. fᵣₑₚ₁ and fᵣₑₚ₂ are different from each other, and fᵣₑₚ₂=fᵣₑₚ₁+δfᵣₑₚ is satisfied. δfᵣₑₚ is much smaller than fᵣₑₚ₁. δfᵣₑₚ is, for example, higher than or equal to 1 Hz and lower than or equal to 10 MHz.

As a result of interference between each of a plurality of frequency peaks included in the frequency spectrum of the first optical comb and a closest one of a plurality of frequency peaks included in the frequency spectrum of the second optical comb, the interference light having the frequency spectrum illustrated in a lower part of FIG. 2 is detected. The detected interference light is beat light caused by the first and second optical combs. The interference light or the beat light is also referred to as a dual comb signal. A frequency interval of the interference light is δfᵣₑₚ, which is a difference between the repetition frequency fᵣₑₚ₁ of the first optical comb and the repetition frequency fᵣₑₚ₂ of the second optical comb. A common detector does not have a resolution high enough to detect each of the frequency peaks. The detector, therefore, detects spectra having shapes indicated by broken lines in FIG. 2.

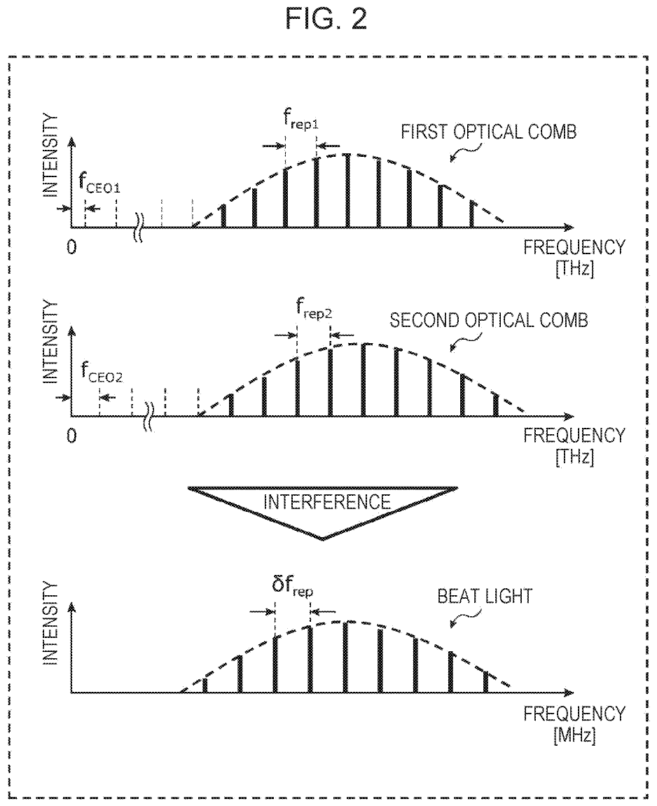

FIG. 3 is a diagram for describing a problem that can arise in a dual comb. In an example illustrated in FIG. 3, unlike the case illustrated in FIG. 2, a frequency band of the spectrum of the first optical comb and a frequency band of the spectrum of the second optical comb do not overlap much. A frequency band of a spectrum may be defined as a range between both ends of a broken line in a drawing. When an overlap between frequency bands is small, the number of frequency peaks interfering with each other is small. As a result, a band of a frequency spectrum of a dual comb signal becomes narrow, and intensity of the signal decreases. Peak intensity of pulses in a time waveform also decreases.

When a dual comb signal is measured, therefore, it is required that an optical spectrum of at least one of a first optical comb or a second optical comb be adjusted such that an overlap between a frequency spectrum of the first optical comb and a frequency spectrum of the second optical comb becomes large. In practice, interference also occurs in regions outside the overlap, but detection of such interference is difficult with a common detector and leads to a decrease in measurement accuracy.

Although details will be described later, a mode-locked laser light source including a gain medium can be used as each of light sources of the first and second optical combs. When the gain media of the two mode-locked laser light sources are the same, the overlap between the frequency bands of the spectra of the two optical combs can be sufficiently increased. When a laser light source called an “on-chip comb”, which is integrated on a semiconductor substrate, is used as the mode-locked laser light source, however, it is difficult to form the same gain medium due to a process error and the like. As a result, even if two on-chip combs are driven under the same driving conditions, the overlap between the frequency bands of the two optical combs can be small.

In order to check the overlap between the optical spectra before the measurement, a spectrometer needs to be used. When a spectrometer is used, however, a measurement apparatus increases in size, and power consumption increases as a result of an increase in the amount of processing. It is desired, therefore, to adjust an optical spectrum with simple means that does not use a spectrometer. In the following description, a measurement apparatus according to a first embodiment, which is capable of adjusting an optical spectrum without using a spectrometer and increasing measurement accuracy will be described.

### Configuration

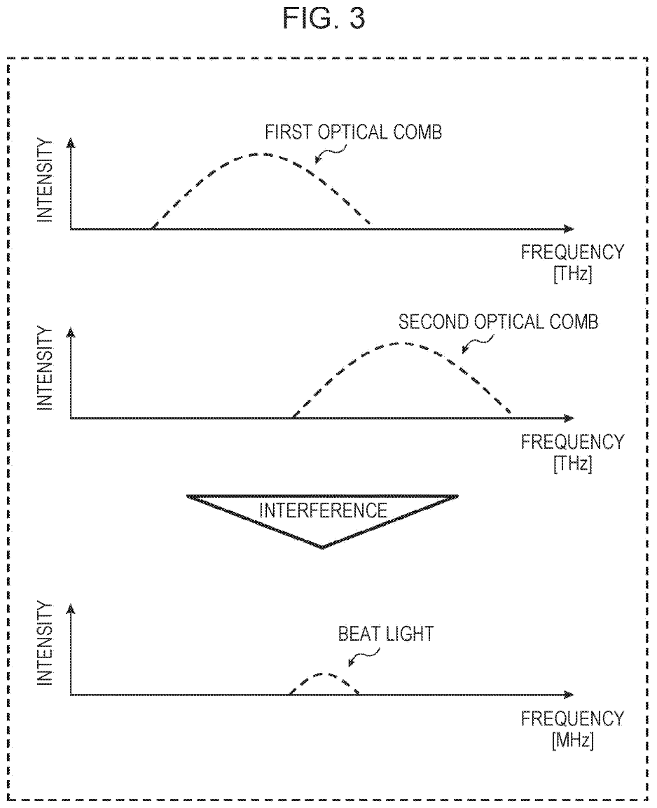

FIG. 4 is a diagram illustrating configuration of a measurement apparatus 100 according to the first embodiment. First, a basic configuration example of the measurement apparatus 100 according to the present embodiment will be described with reference to FIG. 4. The measurement apparatus 100 measures a distance from the measurement apparatus 100 to a target 60, that is, performs ranging. Alternatively, the measurement apparatus 100 may inspect a shape of the target 60 or the like.

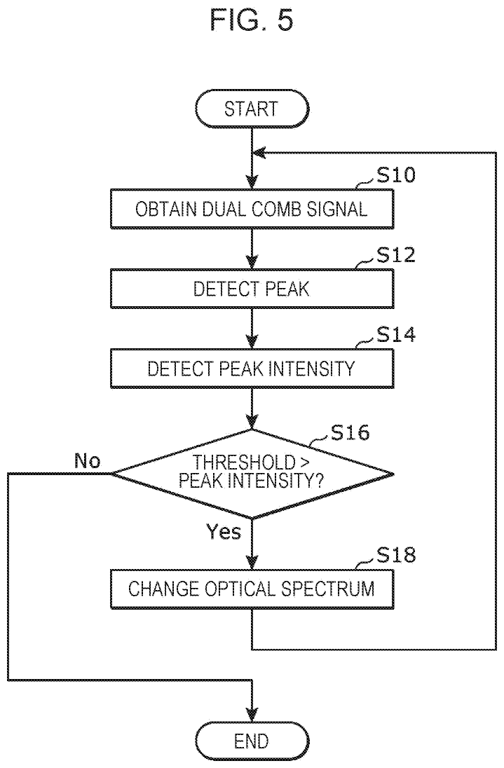

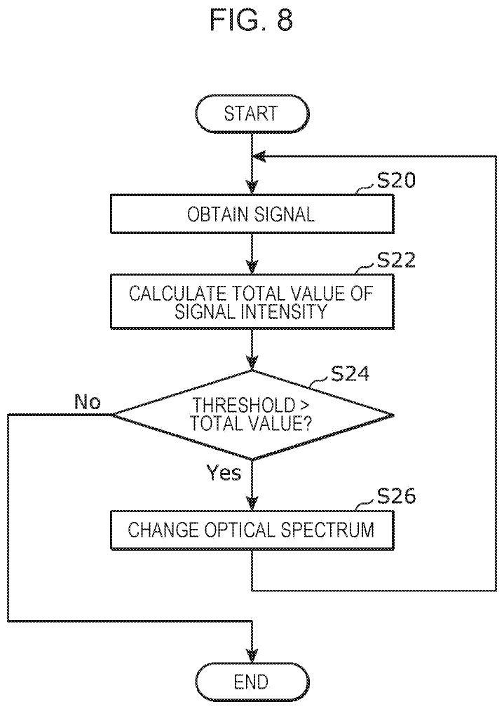

As illustrated in FIG. 4, the measurement apparatus 100 includes a first laser light source 10, a second laser light source 20, detectors 70 and 71, a signal processor 80, and feedback circuits 90 and 91. The measurement apparatus 100 includes couplers 30, 31, 32, and 33, a circulator 40, and a collimator 50 as optical elements for adjusting optical paths. In FIG. 4, broken lines connecting rectangular or circular blocks indicating components represent optical fiber for transmitting light. Solid lines connecting rectangular blocks indicating components represent signal lines for transmitting electrical signals. Although the signal lines are wired lines, wireless links may be used, instead. This also holds for FIGS. 6 and 9, which will be referred to later.

The first laser light source 10 is an example of a mode-locked laser light source including a gain medium. The first laser light source 10 outputs a first optical comb 10L as output light. The first optical comb 10L is, as illustrated in an upper part of FIG. 2, for example, laser light having the repetition frequency fᵣₑₚ₁ and the carrier-envelope offset frequency f_{CEO1}.

The second laser light source 20 is an example of a mode-locked laser light source including a gain medium. The second laser light source 20 outputs a second optical comb 20L as output light. The second optical comb 20L has a repetition frequency different from that of the first optical comb 10L. The second optical comb 20L is, as illustrated in a middle part of FIG. 2, for example, laser light having the repetition frequency fᵣₑₚ₂ and the carrier-envelope offset frequency f_{CEO2}.

In the present embodiment, the first laser light source 10 and the second laser light source 20 are on-chip combs. That is, the first laser light source 10 and the second laser light source 20 are integrated on semiconductor substrates. The semiconductor substrate on which the first laser light source 10 is integrated and the semiconductor substrate on which the second laser light source 20 is integrated may be the same or different from each other. In other words, the first laser light source 10 and the second laser light source 20 may be integrated on the same semiconductor substrate, or the first laser light source 10 may be disposed on a semiconductor substrate different from a semiconductor substrate on which the second laser light source 20 is disposed.

The on-chip combs each include, for example, a resonator including an optical waveguide having mirrors disposed at both ends, and a gain medium and a saturable absorber disposed between the mirrors. The gain medium induces stimulated emission of light in response to supplied charge. The emitted light is repeatedly reflected by the mirrors at both ends of the optical waveguide. The light is amplified as a result of passing through the gain medium multiple times during the repeated reflection. The amplified light becomes an optical pulse train mode-synchronized (mode-locked) by the saturable absorber. One of the two mirrors disposed at both ends of the optical waveguide has a lower reflectance than that of the other, and emits a part of the light from the optical waveguide to the outside as laser light, that is, an optical comb. Such a configuration of the on-chip comb is just an example, and any configuration may be employed insofar as an optical comb can be emitted.

The couplers 30, 31, 32, and 33 are optical elements that separate or combine light.

The circulator 40 is an optical element that controls a travel direction of light.

The collimator 50 is an optical element that emits light as collimated light. A light collecting element such as a lens may be provided on a light emission side of the collimator 50.

The detectors 70 and 71 are optical elements that generate and output electrical signals by converting incident light into charge. Signal levels of the electrical signals correspond to intensity of the incident light. The detectors 70 and 71 are, for example, photoelectric conversion elements such as photodiodes or phototransistors.

The detector 70 is an example of a first detector in the present disclosure, and detects at least one of the first laser light emitted from the first laser light source 10, the second laser light emitted from the second laser light source 20, or beat light caused by the first laser light and the second laser light. The first laser light means not only light immediately after being emitted from the first laser light source 10 (specifically, the first optical comb 10L) but also light in general originating from the first laser light source 10. That is, the first laser light also refers to light obtained when the first optical comb 10L emitted from the first laser light source 10 is subjected to an optical change such as separation, combination, reflection, or collection (specifically, light 10Lt and 10Lr and reflected light 10R). Similarly, the second laser light means not only light immediately after being emitted from the second laser light source 20 (specifically, the second optical comb 20L) but also light in general originating from the second laser light source 20. That is, the second laser light also refers to light obtained when the second optical comb 20L emitted from the second laser light source 20 is subjected to an optical change such as separation, combination, reflection, or collection (specifically, light 20Lt and 20Lr).

The detector 70 is also an example of a third detector in the present disclosure, and detects interference light caused as a result of interference between the first laser light and the second laser light. The interference light detected by the detector 70 is beat light caused by the first laser light and the second laser light. Specifically, the detector 70 detects interference light caused as a result of interference between the light 10Lr and the light 20Lr.

The detector 71 is an example of a second detector in the present disclosure, and detects interference light caused as a result of interference between reflected light caused when the first laser light is reflected from the target 60 and the second laser light. The interference light detected by the detector 71 is beat light caused by the first laser light and the second laser light. Specifically, the detector 71 detects interference light caused as a result of interference between the reflected light 10R and the light 20Lt.

The signal processor 80 processes a signal output from each of the detectors 70 and 71. In the present embodiment, a dual comb signal is output from each of the detectors 70 and 71. For example, the signal processor 80 calculates a distance from the measurement apparatus to the target 60 on the basis of the dual comb signal output from each of the detectors 70 and 71. The signal processor 80 may calculate a distance from the measurement apparatus to each of portions of a surface of the target 60, instead. As a result, the signal processor 80 can obtain information regarding a surface shape of the target 60.

The feedback circuit 90 changes an optical spectrum of the first optical comb 10L on the basis of intensity of a signal output from the detector 70. The feedback circuit 91 changes an optical spectrum of the second optical comb 20L on the basis of intensity of a signal output from the detector 70. In the present embodiment, the intensity of the signal output from the detector 70 is peak intensity of pulses of light detected by the detector 70. Specifically, the intensity of the signal output from the detector 70 is peak intensity of pulses of beat light.

For example, when the intensity of the signal output from the detector 70 is lower than a threshold, the feedback circuit 90 changes a central wavelength of the first optical comb 10L by changing a value of a current applied to the gain medium of the first laser light source 10. When the intensity of the signal output from the detector 70 is lower than the threshold, the feedback circuit 91 changes a central wavelength of the second optical comb 20L by changing a value of a current applied to the gain medium of the second laser light source 20.

The central wavelength of the first optical comb 10L corresponds to a central frequency of a frequency band of the first optical comb 10L. The central frequency is an intermediate value between a high-frequency end and a low-frequency end of a frequency band. Alternatively, the central wavelength of the first optical comb 10L may be defined as corresponding to a frequency of a most intense one of a plurality of frequency components included in the first optical comb 10L. The same holds for the central wavelength of the second optical comb 20L.

The amount of change in an optical spectrum is represented by the amount of shift of a central frequency or the amount of shift of a central wavelength. For example, the feedback circuit 90 changes the optical spectrum of the first optical comb 10L at a frequency higher than at least one of the repetition frequency fᵣₑₚ₁ of the first optical comb 10L or the repetition frequency fᵣₑₚ₂ of the second optical comb 20L. The feedback circuit 91 changes the optical spectrum of the second optical comb 20L at a frequency higher than at least one of the repetition frequency fᵣₑₚ₁ of the first optical comb 10L or the repetition frequency fᵣₑₚ₂ of the second optical comb 20L.

The measurement apparatus 100 may include at least one of the feedback circuit 90 or the feedback circuit 91. That is, the measurement apparatus 100 may include a feedback circuit that changes the optical spectrum of at least one of the first optical comb 10L or the second optical comb 20L on the basis of the intensity of the signal output from the detector 70.

The signal processor 80 and the feedback circuits 90 and 91 are each implemented as, for example, a large-scale integration (LSI) circuit, which is an integrated circuit (IC). The IC is not limited to an LSI circuit, and may be a dedicated circuit or a general-purpose processor. For example, the signal processor 80 and the feedback circuits 90 and 91 may each be a microcontroller, instead. The microcontroller includes, for example, a nonvolatile memory storing a program, a volatile memory, which is a temporary storage area for executing the program, input/output ports, and a processor that executes the program. Alternatively, the signal processor 80 and the feedback circuits 90 and 91 may each be a field-programmable gate array (FPGA) or a reconfigurable processor, in which connections and settings of circuit cells in an LSI circuit can be reconfigured. Functions executed by the signal processor 80 and the feedback circuits 90 and 91 may be implemented as software or may be implemented as hardware. The signal processor 80 and the feedback circuits 90 and 91 may be implemented as a common hardware configuration. The feedback circuits 90 and 91 may each include a current source of a current to be supplied to the gain medium.

Next, main connection relationships of the components described above will be described. Specifically, connection relationships of components relating to the optical paths of the first and second optical combs 10L and 20L will be described.

Many of the components of the measurement apparatus 100 are connected by the optical fiber indicated by the broken lines in FIG. 4. Specifically, the couplers 30, 31, 32, and 33, the circulator 40, the collimator 50, and the detectors 70 and 71 are disposed on paths of the optical fiber. The first laser light source 10 and the second laser light source 20 are connected at ends of the optical fiber.

The coupler 30 separates the first optical comb 10L into the light 10Lt and the light 10Lr. The light 10Lt is an optical comb for measurement and emitted toward the target 60. The light 10Lr is an optical comb for reference.

The light 10Lt passes through the circulator 40, is emitted from the collimator 50, and is incident on the target 60. The light 10Lt is then reflected from the target 60. The reflected light 10R caused as a result of the reflection from the target 60 is incident on the collimator 50 and then directed by the circulator 40 toward the coupler 33. The light 10Lr is directed from the coupler 30 toward the coupler 32.

The coupler 31, on the other hand, separates the second optical comb 20L into the light 20Lr and the light 20Lt. The light 20Lt is an optical comb for measurement. The light 20Lr is an optical comb for reference.

The light 20Lr is combined with the light 10Lr in the coupler 32 and directed toward the detector 70. The light 20Lt is combined with the reflected light 10R in the coupler 33 and directed toward the detector 71. These light beams interfere with each other in the detector 70 or 71 to cause beat light, and optical information is converted into an electrical signal. The electrical signal output from each of the detectors 70 and 71 is input to the signal processor 80. The signal processor 80 performs arithmetic processing using the electrical signal output from the detector 70 as a reference signal and the electrical signal output from the detector 71 as a measurement signal to calculate the distance from the measurement apparatus 100 to the target 60.

### Operation

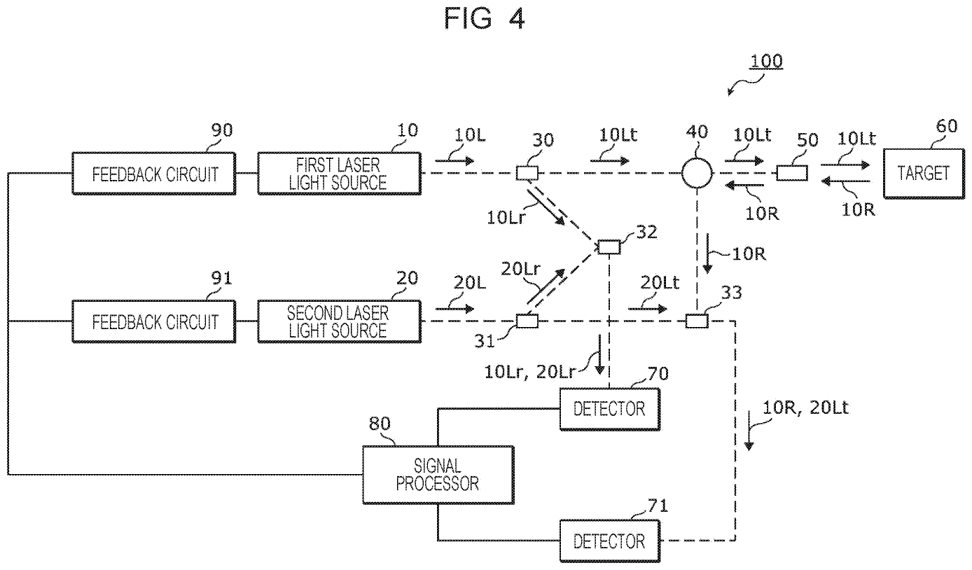

Next, an example of operation of the measurement apparatus 100 according to the present embodiment will be described with reference to FIG. 5. FIG. 5 is a flowchart illustrating the operation of the measurement apparatus 100 according to the present embodiment. The operation illustrated in FIG. 5 is performed, for example, before the target 60 is measured.

As illustrated in FIG. 5, first, the signal processor 80 obtains a dual comb signal output from the detector 70 (S10). Specifically, first, the first laser light source 10 emits the first optical comb 10L, and the second laser light source 20 emits the second optical comb 20L. The light 10Lr of the first optical comb 10L separated by the coupler 30 and the light 20Lr of the second optical comb 20L separated by the coupler 31 are combined together in the coupler 32 and incident on the detector 70. The detector 70 converts beat light caused by the incident light 10Lr and light 20Lr into an electrical signal and outputs the electrical signal to the signal processor 80 as a dual comb signal.

Next, the signal processor 80 detects a peak of a pulse waveform of the obtained dual comb signal (S12). The signal processor 80 then detects intensity of the detected peak (S14). The signal processor 80 outputs information indicating the peak intensity to the feedback circuits 90 and 91. The detection of the peak and the detection of the peak intensity may be performed by the feedback circuits 90 and 91, instead.

Next, the feedback circuits 90 and 91 compare the peak intensity and a threshold (S16). The threshold is a value determined in advance as a lower limit value of peak intensity necessary to accurately measure the target 60. If the peak intensity is higher than or equal to the threshold (NO in S16), the target 60 can be measured, and the process ends. The comparison between the peak intensity and the threshold may be performed by the signal processor 80, instead.

If the peak intensity is lower than the threshold (YES in S16), at least one of the feedback circuit 90 or the feedback circuit 91 changes the optical spectrum of at least one of the first optical comb 10L or the second optical comb 20L (S18). Specifically, at least one of the feedback circuit 90 or the feedback circuit 91 moves the central frequency (or the central wavelength) of at least one of the first optical comb 10L or the second optical comb 20L such that the overlap between the frequency bands of the first and second optical combs 10L and 20L increases. After the optical spectrum is changed, the processing beginning with the obtaining of a dual comb signal (S10 to S18) is repeatedly performed until the peak intensity becomes higher than or equal to the threshold.

As described above, with the measurement apparatus 100 according to the present embodiment, the optical spectrum of at least one of the first optical comb 10L or the second optical comb 20L is changed such that the peak intensity becomes higher than or equal to the threshold. As a result, since the measurement can be performed in a state in which interference light intense enough to perform the measurement can be obtained, the measurement accuracy can be increased.

In the present embodiment, the feedback circuits 90 and 91 may change the optical spectrum on the basis of the signal output from the detector 71. For example, the detector 71 detects light in a state in which a reflector that reflects the light 10Lt is disposed between the collimator 50 and the target 60. The detector 71 detects beat light caused by reflected light caused when the light 10Lt is reflected from the reflector and the light 20Lt. At least one of the feedback circuit 90 or the feedback circuit 91 may change the optical spectrum of at least one of the first optical comb 10L or the second optical comb 20L on the basis of the intensity of the signal output from the detector 71. As in the case of the measurement of the target 60, the detector 71 may detect the beat light caused by the reflected light 10R from the target 60 and the light 20Lt without a reflector being provided.

### Second Embodiment

Next, a second embodiment will be described.

The second embodiment is mainly different from the first embodiment in that a measurement apparatus includes a detector for feedback and a bandpass filter disposed on a light incident side of the detector. In the following description, differences from the first embodiment will be mainly described, and description of common features is omitted or simplified.

FIG. 6 is a diagram illustrating configuration of a measurement apparatus 200 according to the present embodiment. The measurement apparatus 200 illustrated in FIG. 6 is mainly different from the measurement apparatus 100 illustrated in FIG. 4 in that the measurement apparatus 200 includes couplers 34 and 35, detectors 72 and 73, a signal processor 81, and bandpass filters 210 and 211.

The couplers 34 and 35 are optical elements that separate or combine light.

The coupler 34 is provided in order to separate the light 10Lr, which is a part of the first optical comb 10L emitted from the first laser light source 10. The coupler 34 is connected between the coupler 30 and each of the bandpass filter 210 and the coupler 32. The coupler 34 separates the light 10Lr from the coupler 30 into light 11Lr and light 12Lr. The light 11Lr is directed toward the bandpass filter 210. The light 12Lr is directed toward the coupler 32.

Arrangement of the coupler 34 is not particularly limited insofar as a part of the first optical comb 10L can be directed toward the bandpass filter 210. For example, the coupler 34 may be disposed between the first laser light source 10 and the coupler 30, instead.

The coupler 35 is provided in order to separate the light 20Lr, which is a part of the second optical comb 20L emitted from the second laser light source 20. The coupler 35 is provided between the coupler 31 and each of the bandpass filter 211 and the coupler 32. The coupler 35 separates the light 20Lr from the coupler 31 into light 21Lr and light 22Lr. The light 21Lr is directed toward the bandpass filter 211. The light 22Lr is directed toward the coupler 32. The light 22Lr is combined with the light 12Lr in the coupler 32 and directed toward the detector 70.

Arrangement of the coupler 35 is not particularly limited insofar as a part of the second optical comb 20L can be directed toward the bandpass filter 211. For example, the coupler 35 may be disposed between the second laser light source 20 and the coupler 31, instead.

Processing performed by each of the detectors 70 and 71 and the signal processor 80 is substantially the same as in the first embodiment. In the present embodiment, the detectors 70 and 71 and the signal processor 80 perform processing for measuring the target 60 without performing processing for adjusting an optical spectrum using the feedback circuits 90 and 91.

The detectors 72 and 73 are optical elements that generate and output electrical signals by converting incident light into charge. Signal levels of the electrical signals correspond to intensity of the incident light. The detectors 72 and 73 are, for example, photoelectric conversion elements such as photodiodes or phototransistors. The detectors 72 and 73 are other examples of the first detector in the present disclosure.

The detector 72 detects the first laser light that has passed through the corresponding bandpass filter. Specifically, the detector 72 detects the light 11Lr that has passed through the bandpass filter 210.

The detector 73 detects the second laser light that has passed through the corresponding bandpass filter. Specifically, the detector 73 detects the light 21Lr that has passed through the bandpass filter 211.

The bandpass filters 210 and 211 each have a pass band that allows incident light to pass therethrough and stop bands that suppress transmission of incident light. The stop bands are provided for a high-frequency side (short-wavelength side) and a low-frequency side (long-wavelength side) of the pass band, respectively.

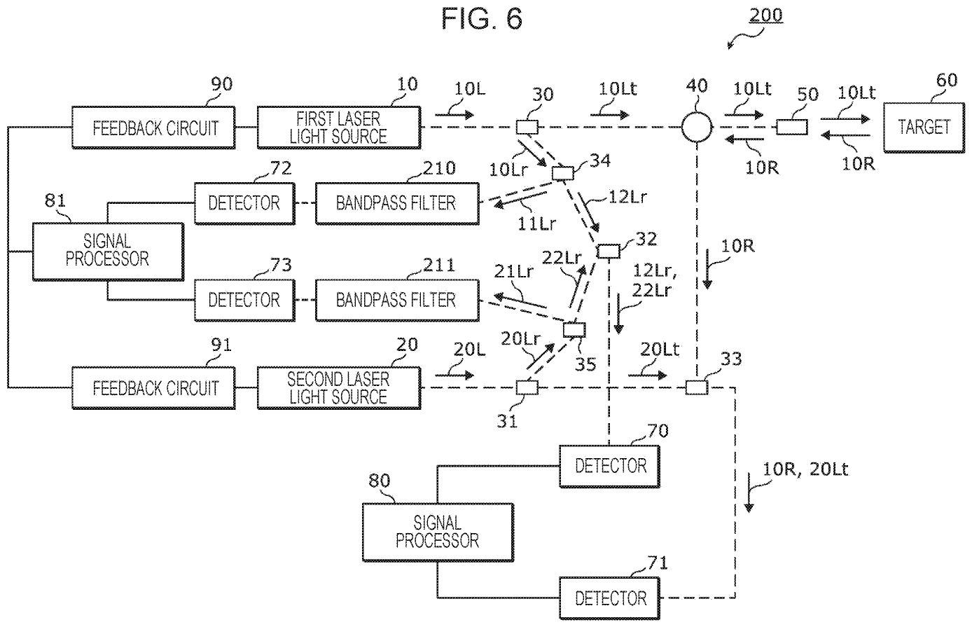

FIG. 7 is a diagram illustrating a relationship between the frequency spectra of the first and second optical combs 10L and 20L and the bandpass filters. Specifically, an upper part of FIG. 7 illustrates a relationship between the light 11Lr, which is a part of the first optical comb 10L, and the pass band of the bandpass filter 210. A lower part of FIG. 7 illustrates a relationship between the light 21Lr, which is a part of the second optical comb 20L, and the pass band of the bandpass filter 211. In the present embodiment, the pass band of the bandpass filter 210 and the pass band of the bandpass filter 211 are identical.

The bandpass filter 210 is disposed on a light incident side of the detector 72. That is, the bandpass filter 210 is disposed such that light that has passed through the bandpass filter 210 is incident on the detector 72. A part of the first optical comb 10L emitted from the first laser light source 10, or more specifically the light 11Lr separated by the coupler 34, is incident on the bandpass filter 210. The detector 72 detects only light corresponding to a frequency component of the light 11Lr that has passed through the bandpass filter 210. When the central frequency of the first optical comb 10L is included in the pass band of the bandpass filter 210, intensity of light detected by the detector 72 is high. As the central frequency of the first optical comb 10L becomes close to a central frequency of the pass band of the bandpass filter 210, the intensity of the light detected by the detector 72 further increases.

The bandpass filter 211 is disposed on a light incident side of the detector 73. That is, the bandpass filter 211 is disposed such that light that has passed through the bandpass filter 211 is incident on the detector 73. A part of the second optical comb 20L emitted from the second laser light source 20, or more specifically the light 21Lr separated by the coupler 35, is incident on the bandpass filter 211. The detector 73 detects only light corresponding to a frequency component of the light 21Lr that has passed through the bandpass filter 211. When the central frequency of the second optical comb 20L is included in the pass band of the bandpass filter 211, intensity of light detected by the detector 73 is high. As the central frequency of the second optical comb 20L becomes close to the central frequency of the pass band of the bandpass filter 211, the intensity of the light detected by the detector 73 further increases.

The pass band of the bandpass filter 210 is narrower than the frequency band of the spectrum of the first optical comb 10L. The pass band of the bandpass filter 211 is narrower than the frequency band of the spectrum of the second optical comb 20L. For example, the pass band of the bandpass filter 210 is 50% or less of the frequency band of the spectrum of the first optical comb 10L, but may be 40% or less, 30% or less, or 20% or less, instead. In an example, the pass band of the bandpass filter 210 is 10% of the frequency band of the spectrum of the first optical comb 10L. Similarly, the pass band of the bandpass filter 211 is 50% or less of the frequency band of the spectrum of the second optical comb 20L, but may be 40% or less, 30% or less, or 20% or less, instead. In an example, the pass band of the bandpass filter 211 is 10% of the frequency band of the spectrum of the second optical comb 20L.

A cutoff shape of the pass band of each of the bandpass filters 210 and 211 is a rectangle, for example, but is not limited to this. The cutoff shape of the pass band of each of the bandpass filters 210 and 211 may be a trapezoid or a curved shape, instead. A pass band of a bandpass filter is a difference between a cutoff frequency on a high-frequency side and a cutoff frequency on a low-frequency side. A cutoff frequency is a frequency at which transmittance becomes 50% of a maximum value thereof in a pass band.

The signal processor 81 processes a signal output from each of the detectors 72 and 73. In the present embodiment, the detector 72 outputs a signal according to intensity of the light 11Lr that has passed through the bandpass filter 210. The detector 73 outputs a signal according to intensity of the light 21Lr that has passed through the bandpass filter 211. In the present embodiment, the signal processor 81 calculates the sum (i.e., a total value) of the intensity of the signal output from the detector 72 and the intensity of the signal output from the detector 73. The signal processor 81 outputs information indicating the calculated sum to each of the feedback circuits 90 and 91.

The signal processor 81 is implemented as, for example, an LSI circuit, which is an IC. The signal processor 81 may be implemented as a hardware configuration common to the signal processor 80.

In the present embodiment, the feedback circuit 90 changes the optical spectrum of the first optical comb 10L on the basis of the intensity of the signal output from each of the detectors 72 and 73. The feedback circuit 91 changes the optical spectrum of the second optical comb 20L on the basis of the intensity of the signal output from each of the detectors 72 and 73. The intensity of the signal output from the detector 72 is intensity of light that has passed through the bandpass filter 210. The intensity of the signal output from the detector 73 is intensity of light that has passed through the bandpass filter 211.

For example, the feedback circuits 90 and 91 compare a total value of the intensity of the light that has passed through the bandpass filter 210 or 211 on the basis of the information output from the signal processor 81 with a threshold. If the total value of the intensity is smaller than the threshold, the feedback circuit 90 changes the central wavelength of the first optical comb 10L by changing the value of the current applied to the gain medium of the first laser light source 10. If the total value of the intensity is smaller than the threshold, the feedback circuit 91 changes the central wavelength of the second optical comb 20L by changing the value of the current applied to the gain medium of the second laser light source 20.

### Operation

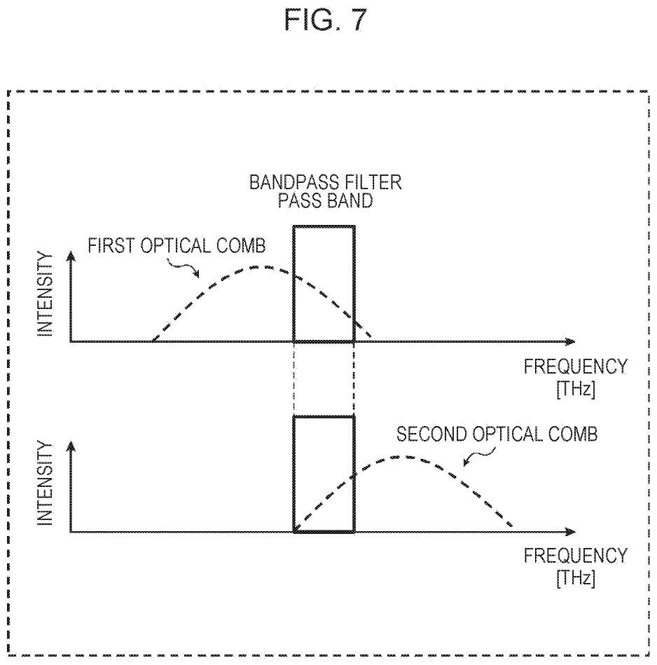

Next, an example of operation of the measurement apparatus 200 according to the present embodiment will be described with reference to FIG. 8. FIG. 8 is a flowchart illustrating the operation of the measurement apparatus 200 according to the present embodiment. The operation illustrated in FIG. 8 is performed, for example, before the target 60 is measured.

As illustrated in FIG. 8, first, the signal processor 81 obtains an optical signal that has passed through the bandpass filter 210 or the bandpass filter 211 (S20). Specifically, first, the first laser light source 10 emits the first optical comb 10L, and the second laser light source 20 emits the second optical comb 20L. The light 11Lr of the first optical comb 10L separated by the couplers 30 and 34 is incident on the detector 72 via the bandpass filter 210. The light 21Lr of the second optical comb 20L separated by the couplers 31 and 35 is incident on the detector 73 via the bandpass filter 211. The detectors 72 and 73 each convert the incident light into an electrical signal and output the electrical signal to the signal processor 81.

Next, the signal processor 81 calculates a total value of intensity of the obtained two signals (S22). The signal processor 81 then outputs information indicating the total value to the feedback circuits 90 and 91. The calculation of the total value of the intensity may be performed by the feedback circuits 90 and 91, instead.

Next, the feedback circuits 90 and 91 compare the total value of the intensity with a threshold (S24). The threshold is a value determined in advance as a lower limit value of intensity necessary to accurately measure the target 60. If the total value of the intensity is larger than or equal to the threshold (NO in S24), the target 60 can be measured, and the process ends. The comparison between the total value of the intensity and the threshold may be performed by the signal processor 81, instead.

If the total value of the intensity is smaller than the threshold (YES in S24), at least one of the feedback circuits 90 and 91 changes the optical spectrum of at least one of the first optical comb 10L or the second optical comb 20L (S26). Specifically, at least one of the feedback circuit 90 or the feedback circuit 91 moves the central frequency (or the central wavelength) of at least one of the first optical comb 10L or the second optical comb 20L such that the central frequency of the first optical comb 10L becomes close to the central frequency of the pass band of the bandpass filter 210 and/or the central frequency of the second optical comb 20L becomes close to the central frequency of the pass band of the bandpass filter 211. After the optical spectrum is changed, the processing beginning with the obtaining of a dual comb signal (S20 to S26) is repeatedly performed until the total value of the intensity becomes larger than or equal to the threshold.

As described above, with the measurement apparatus 200 according to the present embodiment, the optical spectrum of at least one of the first optical comb 10L or the second optical comb 20L is changed such that the total value of the intensity becomes larger than or equal to the threshold. As a result, since the measurement can be performed in a state in which interference light intense enough to perform the measurement can be obtained, the measurement accuracy can be increased.

### Modification

Next, a modification of the above embodiments will be described.

The present modification is mainly different from the second embodiment in that only one pair of a bandpass filter and a detector is included. In addition, the present modification is mainly different from the first embodiment in that a bandpass filter and a detector are included. Differences from the first and second embodiments will be mainly described hereinafter, and description of common features is omitted or simplified.

FIG. 9 is a diagram illustrating configuration of a measurement apparatus 300 according to the present modification. The measurement apparatus 300 illustrated in FIG. 9 is different from the measurement apparatus 100 illustrated in FIG. 4 in that the measurement apparatus 300 includes a coupler 36, a detector 74, and a bandpass filter 310. The measurement apparatus 300 includes a signal processor 82 instead of the signal processor 80.

The coupler 36 is an optical element that separates and combines light. The coupler 36 is provided in order to separate the light 10Lr and the light 20Lr combined by the coupler 32. The coupler 36 is connected between the coupler 32 and each of the detector 70 and the bandpass filter 310. The coupler 36 separates the light 10Lr from the coupler 32 into the light 11Lr and the light 12Lr and the light 20Lr from the coupler 32 into the light 21Lr and the light 22Lr. The light 11Lr and the light 21Lr are directed toward the bandpass filter 310. The light 12Lr and the light 22Lr are directed toward the detector 70.

The detector 74 is an optical element that generates and outputs an electrical signal by converting incident light into charge. A level of the electrical signal corresponds to intensity of the incident light. The detector 74 is, for example, a photoelectric conversion element such as a photodiode or a phototransistor. The detector 74 is another example of the first detector in the present disclosure. The detector 74 detects the light 11Lr and the light 21Lr that have passed through the bandpass filter 310.

The bandpass filter 310 has a pass band that allows incident light to pass therethrough and stop bands that suppress transmission of incident light. The stop bands are provided for a high-frequency side (short-wavelength side) and a low-frequency side (long-wavelength side) of the pass band, respectively. The bandpass filter 310 is disposed on a light incident side of the detector 74. That is, the bandpass filter 310 is disposed such that light that has passed through the bandpass filter 310 is incident on the detector 74.

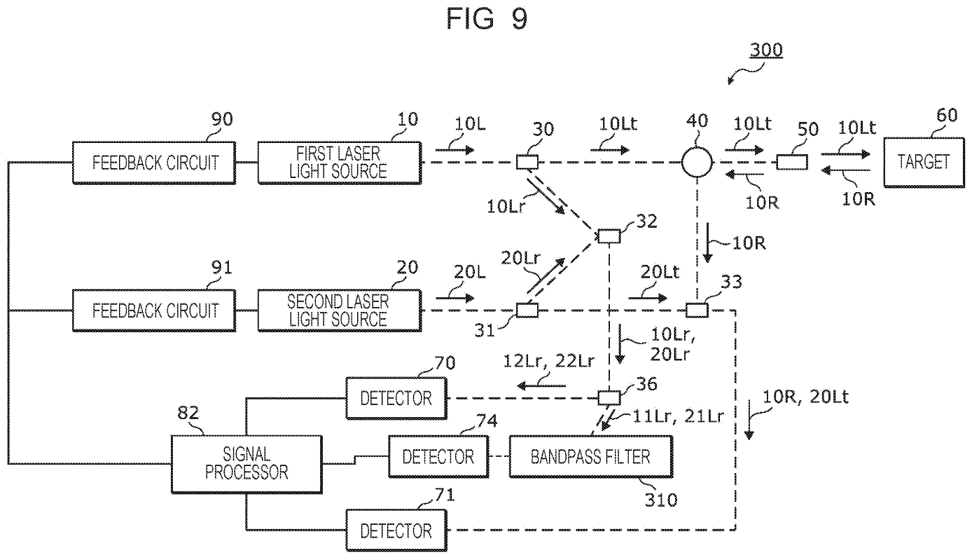

FIG. 10 is a diagram illustrating a relationship between the frequency spectra of the first and second optical combs 10L and 20L and the bandpass filter. A part of the first optical comb 10L emitted from the first laser light source 10 and a part of the second optical comb 20L emitted from the second laser light source 20, or more specifically the light 11Lr and the light 21Lr, are incident on the bandpass filter 310. The detector 74 detects interference light caused as a result of interference between light corresponding to a frequency component of the light 11Lr that has passed through the bandpass filter 310 and light corresponding to a frequency component of the light 21Lr that has passed through the bandpass filter 310. When the central frequency of the first optical comb 10L or the second optical comb 20L is included in the pass band of the bandpass filter 310, intensity of light detected by the detector 74 is high. As the central frequency of the first optical comb 10L or the second optical comb 20L becomes close to the central frequency of the pass band of the bandpass filter 310, the intensity of the light detected by the detector 74 further increases. As the central frequency of each of the first and second optical combs 10L and 20L becomes close to the central frequency of the pass band of the bandpass filter 310, the intensity of the light detected by the detector 74 further increases.

The pass band of the bandpass filter 310 is narrower than the frequency band of the spectrum of the first optical comb 10L and the frequency band of the spectrum of the second optical comb 20L. For example, the pass band of the bandpass filter 310 is 50% or less of the frequency band of the spectrum of each of the first and second optical combs 10L and 20L, but may be 40% or less, 30% or less, or 20% or less, instead. In an example, the pass band of the bandpass filter 310 is 10% of the frequency band of the spectrum of the first optical comb 10L or the second optical comb 20L.

The signal processor 82 processes a signal output from the detector 74 in addition to the processing for calculating a distance. In the present modification, the detector 74 outputs a signal according to intensity of beat light caused by the light 11Lr and the light 21Lr that have passed through the bandpass filter 310. In the present modification, the signal processor 82 outputs information indicating the intensity of the signal output from the detector 74 to each of the feedback circuits 90 and 91.

In the present modification, the feedback circuit 90 changes the optical spectrum of the first optical comb 10L on the basis of the intensity of the signal output from the detector 74. The feedback circuit 91 changes the optical spectrum of the second optical comb 20L on the basis of the intensity of the signal output from the detector 74. The intensity of the signal output from the detector 74 is the intensity of the beat light caused by the first laser light and the second laser light that have passed through the bandpass filter 310.

For example, the feedback circuits 90 and 91 compare the intensity of the beat light of the light that has passed through the bandpass filter 310 with a threshold on the basis of the information output from the signal processor 82. If the intensity is lower than the threshold, the feedback circuit 90 changes the central wavelength of the first optical comb 10L by changing the value of the current applied to the gain medium of the first laser light source 10. If the intensity is lower than the threshold, the feedback circuit 91 changes the central wavelength of the second optical comb 20L by changing the value of the current applied to the gain medium of the second laser light source 20.

### Operation

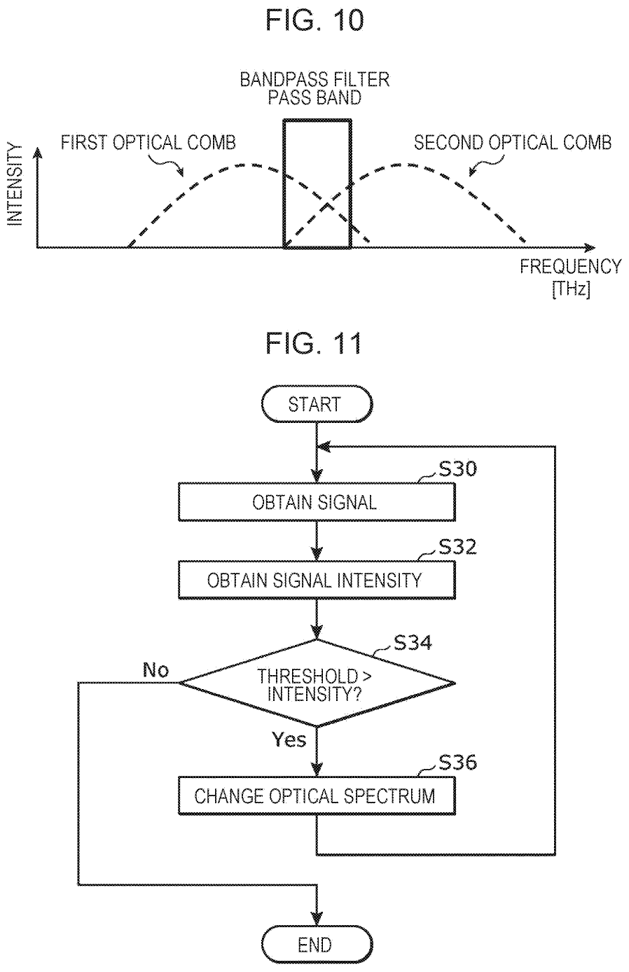

Next, an example of operation of the measurement apparatus 300 according to the present modification will be described with reference to FIG. 11. FIG. 11 is a flowchart illustrating the operation of the measurement apparatus 300 according to the present modification. The operation illustrated in FIG. 11 is performed, for example, before the target 60 is measured.

As illustrated in FIG. 11, first, the signal processor 82 obtains a signal indicating intensity of beat light of light that has passed through the bandpass filter 310 (S30). Specifically, the first laser light source 10 emits the first optical comb 10L, and the second laser light source 20 emits the second optical comb 20L. The light 10Lr of the first optical comb 10L separated by the coupler 30 and the light 20Lr of the second optical comb 20L separated by the coupler 31 are combined by the coupler 32. The light 10Lr and the light 20Lr combined by the coupler 32 are separated by the coupler 36 and are incident on the detector 74 via the bandpass filter 310 as the light 11Lr and the light 21Lr. The detector 74 converts the incident light into an electrical signal and outputs the electrical signal to the signal processor 82.

Next, the signal processor 82 detects intensity of the obtained signal (S32). The signal processor 82 then outputs information indicating the detected signal intensity to the feedback circuits 90 and 91. The detection of the signal intensity may be performed by the feedback circuits 90 and 91, instead.

Next, the feedback circuits 90 and 91 compare the signal intensity with a threshold (S34). The threshold is a value determined in advance as a lower limit value of signal intensity necessary to accurately measure the target 60. If the signal intensity is higher than or equal to the threshold (NO in S34), the target 60 can be measured, and the process ends. The comparison between the signal intensity and the threshold may be performed by the signal processor 82, instead.

If the signal intensity is lower than the threshold (YES in S34), at least one of the feedback circuit 90 or the feedback circuit 91 changes the optical spectrum of at least one of the first optical comb 10L or the second optical comb 20L (S36). Specifically, at least one of the feedback circuit 90 or the feedback circuit 91 moves the central frequency (or the central wavelength) of at least one of the first optical comb 10L or the second optical comb 20L such that the central frequency of the first optical comb 10L and/or the central frequency of the second optical comb 20L become close to the central frequency of the pass band of the bandpass filter 310. After the optical spectrum is changed, the processing beginning with the obtaining of a dual comb signal (S30 to S36) is repeatedly performed until the signal intensity becomes higher than or equal to the threshold.

As described above, with the measurement apparatus 300 according to the present modification, the optical spectrum of at least one of the first optical comb 10L or the second optical comb 20L is changed such that the signal intensity becomes higher than or equal to the threshold. As a result, since the measurement can be performed in a state in which interference light intense enough to perform the measurement can be obtained, and the measurement accuracy can be increased.

### Other Embodiments

Although the measurement apparatuses according to one or a plurality of aspects have been described on the basis of embodiments, the present disclosure is not limited to these embodiments. The scope of the present disclosure also includes modes obtained by modifying the embodiments in various ways conceivable by those skilled in the art and modes constructed by combining components from different embodiments.

For example, although a case where both the first laser light source and the second laser light source are on-chip combs has been described in the above embodiments, the first laser light source and the second laser light source are not limited to this. For example, the first laser light source and the second laser light source may each be a solid-state laser light source, instead. In the case of the solid-state laser light source, a feedback circuit can change an optical spectrum of laser light by changing dispersion using an optical element such as a prism pair provided within a resonator.

For example, in the second embodiment and the modification, the pass bands of the bandpass filters may be swept.

In addition, for example, in the above embodiments, a processing step performed by a specific processor may be performed by another processor, instead. Order of a plurality of processing steps may be changed, or a plurality of processing steps may be performed in parallel with each other.

In addition, for example, the processing described in the above embodiments may be achieved through centralized processing using a single apparatus (or a system), or may be achieved through distributed processing using a plurality of apparatuses. The program may be executed by a single processor, or may be executed by a plurality of processors. That is, centralized processing may be performed, or distributed processing may be performed.

In addition, in the above embodiment, a subset or all of the components such as the signal processors 80 and 81 may be implemented as dedicated hardware or may be achieved by executing software programs suitable for the corresponding components. Each component may be achieved when a program executor such as a central processing unit (CPU) or a processor reads and executes the corresponding software program stored in a storage medium such as a hard disk drive (HDD) or a semiconductor memory.

The components such as the signal processors 80 and 81 may be implemented as one or a plurality of electronic circuits. The one or plurality of electronic circuits may each be a general-purpose circuit or may be a dedicated circuit.

The one or plurality of electronic circuits may include, for example, a semiconductor device, an IC, or an LSI circuit. The IC or the LSI circuit may be integrated on a single chip, or may be integrated on a plurality of chips. Although the terms “IC” and “LSI” are used here, a term used changes depending on a degree of integration, and “system LSI”, “very-large-scale integration (VLSI)”, or “ultra-large-scale-integration (ULSI)” might be used, instead. An FPGA, which is programmed after an LSI circuit is manufactured, can also be used for the same purpose.

General or specific aspects of the present disclosure may be achieved by a system, an apparatus, a method, an IC, or a computer program. Alternatively, the general or specific aspects of the present disclosure may be achieved by a non-transitory computer-readable storage medium storing the computer program, such as an optical disc, an HDD, or a semiconductor memory. The general or specific aspects of the present disclosure may be achieved by any selective combination of a system, an apparatus, a method, an IC, a computer program, and a storage medium.

Each of the above embodiments may be subjected to various types of modification, replacement, addition, omission, and the like within the claims or its equivalent range.

The present disclosure can be used for an apparatus, a system, a method, and the like that perform ranging, displacement measurement, or the like, and, for example, can be used for a range sensor, a displacement meter, a shape inspection apparatus, and the like.

What is claimed is:

1. A measurement apparatus comprising:
a first laser light source that is a mode-locked laser light source including a gain medium and that emits first laser light;
a second laser light source that is a mode-locked laser light source including a gain medium and that emits second laser light;
at least one first detector that detects at least one selected from the group consisting of the first laser light, the second laser light, and beat light caused by the first laser light and the second laser light; and
a feedback circuit that changes at least one selected from the group consisting of an optical spectrum of the first laser light and an optical spectrum of the second laser light on a basis of intensity of a signal output from the at least one first detector.

2. The measurement apparatus according to claim 1,
wherein the first laser light source and the second laser light source are integrated on a same semiconductor substrate.

3. The measurement apparatus according to claim 1,
wherein the first laser light source is disposed on a semiconductor substrate different from a semiconductor substrate on which the second laser light source is disposed.

4. The measurement apparatus according to claim 1,
wherein the feedback circuit changes the optical spectrum at a frequency higher than at least one selected from the group consisting of a repetition frequency of the first laser light and a repetition frequency of the second laser light.

5. The measurement apparatus according to claim 1,
wherein the intensity of the signal output from the at least one first detector is peak intensity of pulses of light detected by the at least one first detector.

6. The measurement apparatus according to claim 1, further comprising:
at least one bandpass filter, wherein
the at least one bandpass filter is disposed such that light that has passed through the at least one bandpass filter is incident on the at least one first detector, and
the intensity of the signal output from the at least one first detector is intensity of the light that has passed through the at least one bandpass filter.

7. The measurement apparatus according to claim 1,
wherein the feedback circuit changes the optical spectrum by adjusting an amount of current applied to the gain medium.

8. The measurement apparatus according to claim 1, further comprising:
a second detector that detects interference light caused as a result of interference between reflected light caused when the first laser light is reflected from a target and the second laser light; and
a signal processor that calculates a distance from the measurement apparatus to the target on a basis of a signal output from the second detector.

9. The measurement apparatus according to claim 1, further comprising:
a signal processor that calculates a distance from the measurement apparatus to a target on a basis of the signal output from the at least one first detector.

10. The measurement apparatus according to claim 6, further comprising:
a second detector that detects interference light caused as a result of interference between reflected light caused when the first laser light is reflected from a target and the second laser light;
a third detector that detects interference light caused as a result of interference between the first laser light and the second laser light; and
a signal processor that calculates a distance from the measurement apparatus to the target on a basis of a signal output from the second detector and a signal output from the third detector.

11. The measurement apparatus according to claim 10, wherein
the at least one first detector includes a plurality of first detectors,
the at least one bandpass filter includes a plurality of bandpass filters,
one of the plurality of first detectors detects the first laser light that has passed through a first corresponding bandpass filter among the plurality of bandpass filters, and
another of the plurality of first detectors detects the second laser light that has passed through a second corresponding bandpass filter among the plurality of bandpass filters.

12. The measurement apparatus according to claim 10,
wherein the at least one first detector detects the beat light caused by the first laser light and the second laser light that have passed through the at least one bandpass filter.

13. A measurement method comprising:
detecting, using a detector, at least one selected from the group consisting of first laser light emitted from a first laser light source that is a mode-locked laser light source including a gain medium, second laser light emitted from a second laser light source that is a mode-locked laser light source including a gain medium, and beat light caused by the first laser light and the second laser light; and
changing at least one selected from the group consisting of an optical spectrum of the first laser light and an optical spectrum of the second laser light on a basis of intensity of a signal output from the detector.
